(19) United States
(12) Patent Application Publication
(10) Pub. No.: US 2009/0328139 A1
(43) Pub. Date: Dec. 31, 2009

(54) NETWORK COMMUNICATION DEVICE

(75) Inventors: Kenichi Kitamura, Kanagawa (JP); Hiroshi Terui, Kanagawa (JP)

Correspondence Address: COOPER & DUNHAM, LLP, 30 Rockefeller Plaza, 20th Floor, NEW YORK, NY, 10112, US

(73) Assignee: Ricoh Company, Ltd., Tokyo (JP)

(21) Appl. No.: 12/123,599

(22) Filed: May 20, 2008

(30) Foreign Application Priority Data
Jun. 14, 2007 (JP) 2007-157654

(51) Int. Cl. H04L 9/32

(52) U.S. Cl. 726/2

(57) ABSTRACT

A disclosed network communication device having plural addresses includes an address obtaining unit configured to obtain plural addresses corresponding to a name or an identifier of another network communication device by address resolution, and an address specifying unit configured to specify one or more of the obtained addresses as security communication addresses with which security communications can be performed by comparing the obtained addresses to a setting of the security communications.

### BACKGROUND OF THE INVENTION

1. Field of the Invention

The present invention relates to a network communication device, such as a printer, a scanner, a fax machine, an MFP (multi function printer) having functions of these devices, and a PC (personal computer), the network communication device having a function for performing network communications according to a protocol such as IPv6 (Internet Protocol version 6) and IPv4 (Internet Protocol version 4).

2. Description of the Related Art

In an IPv6 environment, network communication devices each have plural IP addresses. It should be noted that having plural IP addresses is not dependent on the version of the IP protocol because IPv4 also allows assigning plural IP addresses.

The network communication devices often perform, as security measures, (1) communications using IPsec (Internet Protocol security) and (2) access control based on IP addresses.

IPsec is a general-purpose security technology, which is designed to encrypt and authenticate IP packets and can be used in a TCP/IP (Transmission Control Protocol/Internet Protocol) environment. Unlike tunneling protocols that operate at the data link layer, IPSec operates at the network layer. The key mechanism of IPsec includes an “AH (Authentication Header)” for performing authentication of packets to prevent tampering with data in the packets and an “ESP (Encapsulating Security Payload)” header for performing processing from authentication to encryption. IPsec supports “tunnel mode” that encrypts the entire IP packet and “transport mode” that encrypts only the data portion of each packet. IPsec uses an automatic key exchange protocol called IKE (Internet Key Exchange) as an algorithm for automatically creating and exchanging encryption/authentication parameters.

The IP address based access control is for controlling access by specifying an IP address or an IP address range (address block) of a network communication device of which access is permitted/denied.

The above security measures taken by the network communication devices having plural IP addresses have the following problems.

(1) Problem with Communications Using IPsec

In communications using IPsec, it is necessary to previously apply the same IPsec setting for enabling network communication devices to communicate with each other. However, in some network communication devices having plural IP address, IPsec is applied to some of its IP addresses but is not applied to the other IP addresses.

When an application requests communications with such a network communication device by specifying the network communication device not by the IP address but by the name (host name) of the DNS (Domain Name System) or the identifier for SIP (Session Initiation Protocol), address resolution for DNS or SIP is used. When address resolution is performed using the name or the identifier, all the (plural) IP addresses associated with the name or the identifier are acquired. However, it is not possible to identify which of the IP addresses the IPsec is applied to.

It is therefore necessary to actually attempt communication with each one of the IP addresses, so that it takes time to start the requested communication.

(2) Problem with the IP Address Based Access Control

If a first network communication device attempts access using an IP address to a second network communication device, the second network communication device determines whether the first network communication device has an access permission by comparing an IP address of the first network communication device to setting information. However, even if the first network communication device has an access permission, in the case where the IP address used when attempting the access is different from an IP address to which the access permission is granted, the access of the first network communication device is denied. Furthermore, IP addresses of network communication devices change frequently depending on the network environment and the status of connection devices. Therefore, if settings are fixed, access control might not operate normally.

### SUMMARY OF THE INVENTION

In view of the forgoing, the present invention is directed to provide a network communication device capable of performing appropriate security operations with another network communication device having plural addresses.

According to an aspect of the present invention there is provided a network communication device having plural addresses, the network communication device comprising an address obtaining unit configured to obtain plural addresses corresponding to a name or an identifier of another network communication device by address resolution; and an address specifying unit configured to specify one or more of the obtained addresses as security communication addresses with which security communications can be performed by comparing the obtained addresses to a setting of the security communications.

According to another aspect of the present invention, there is provided a network communication device having plural addresses, the network communication device comprising an address obtaining unit configured to, if an access request is received from another network communication device with an address access from which address is not permitted, obtain a host name corresponding to the address, and obtain plural addresses corresponding to the obtained host name; and an access controlling unit configured to control access of the other network communication device based on the obtained addresses.

The present invention may be embodied as a method of controlling a network communication device having plural addresses.

In an embodiment of the present invention, there is provided a network communication device configured to be connectable to another network communication device having plural addresses. The network communication device of this embodiment is capable of efficiently specifying one or more of the plural addresses of the other network communication device as security communication addresses with which security communications such as IPsec can be performed, and is capable of performing appropriate security operations with the other network communication device having the plural addresses.

### BRIEF DESCRIPTION OF THE DRAWINGS

FIG. 1 is a diagram showing an exemplary network configuration according to a first embodiment of the present invention;

FIG. 2 is a diagram showing an exemplary software configuration of a network communication device;

FIGS. 3A and 3B are diagrams showing exemplary data structures of an IPsec setting holding unit and an IPsec SA database, respectively;

FIG. 4 is a flowchart showing an exemplary process performed by a network control unit of a network communication device;

FIG. 5 is a flowchart showing another exemplary process performed by a network control unit of a network communication device;

FIG. 6 is a flowchart showing still another exemplary process performed by a network control unit of a network communication device;

FIG. 7 is a flowchart showing a further exemplary process performed by a network control unit of a network communication device;

FIG. 8 is a block diagram showing an exemplary network configuration according to a second embodiment of the present invention;

FIG. 9 is a diagram showing an exemplary software configuration of a network communication device;

FIGS. 10A and 10B are diagrams showing exemplary data structures of an ACL information holding unit;

FIG. 11 is a flowchart showing an exemplary process performed by a network control unit of a network communication device;

FIGS. 12A and 12B are sequence diagrams each showing an exemplary process of transmitting signals between devices; and

FIGS. 13A-13F are flowcharts each showing an exemplary process of updating association information.

### DETAILED DESCRIPTION OF THE PREFERRED EMBODIMENT

Preferred embodiments of the present invention are described below with reference to the accompanying drawings.

### First Embodiment

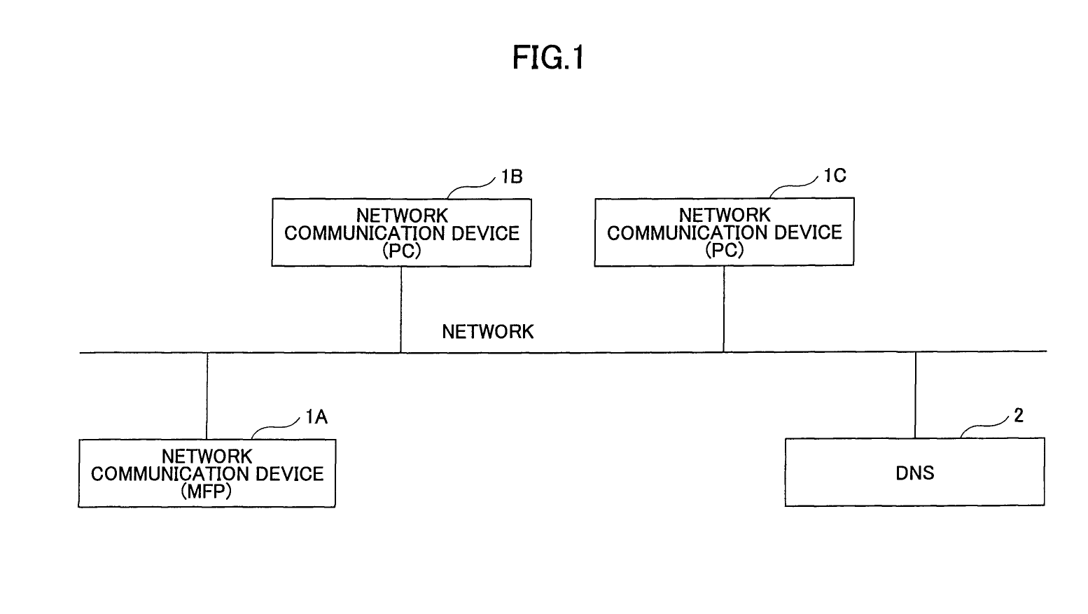

FIG. 1 is a block diagram showing an exemplary network configuration according to a first embodiment of the present invention.

In FIG. 1, a network communication device 1A such as an MFP, network communication devices 1B and 1C such as PCs, and a DNS 2 for performing address resolution are connected over a network. Each of the network communication devices 1A-1C has plural IP addresses. The correspondence information is registered in the DNS 2, which correspondence information indicates correspondence between the host name and the plural IP addresses of each of the network communication devices 1A-1C on the network. Each of the network communication devices 1A-1C may have an IPsec communication setting to perform IPsec communications in one-to-one device relationship as needed. Depending on the setting, each of the network communication devices 1A-1C is able to perform using only one or some of its plural IP addresses.

In the following example, the present invention is applied to the network communication device 1A such as an MFP. However, it should be understood that the present invention is applicable to other network communication devices.

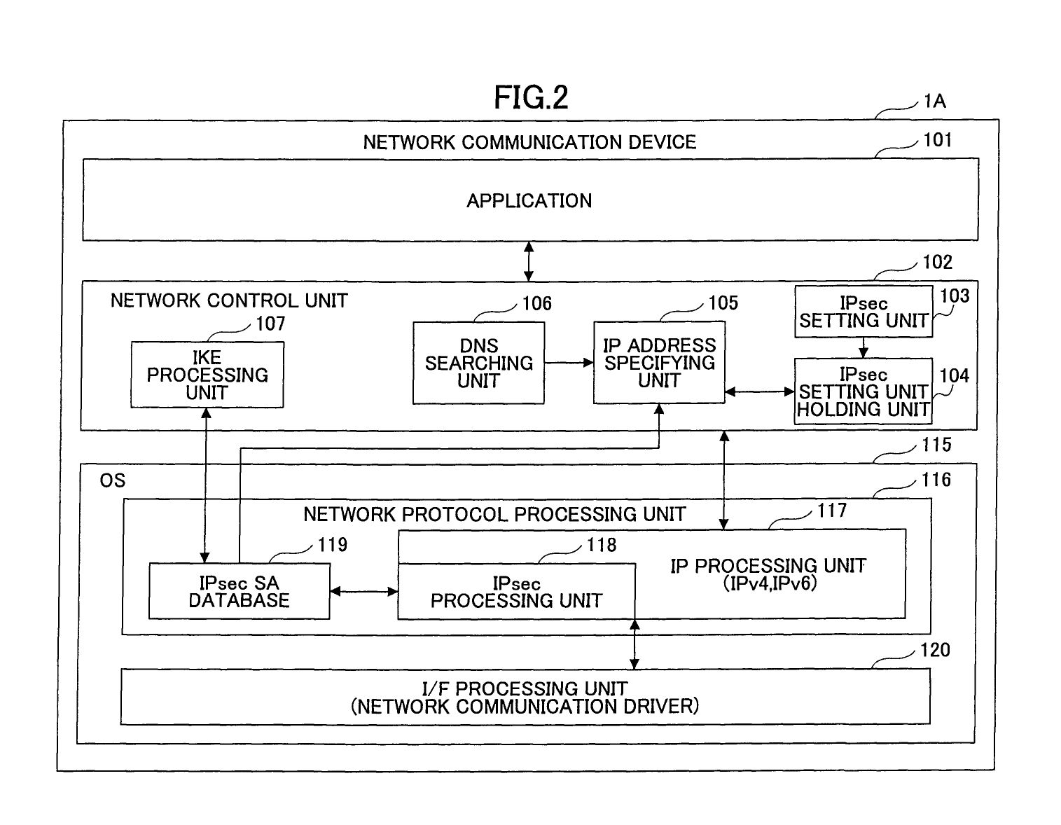

FIG. 2 is a diagram showing an exemplary software configuration of the network communication device 1A.

In FIG. 2, the network communication device 1A includes an application 101 that requests communications via the network, a network control unit 102 that controls network communications, and an OS (Operating System) 115 as basic software of the network communication device 1A.

The network control unit 102 includes an IPsec setting unit 103 that provides an IPsec setting function to be used by an administrator of the network communication device 1A, an IPsec setting holding unit 104 that holds settings of IPsec, an IP address specifying unit 105 that specifies an IP address when the application 101 requests communications by specifying a host name, a DNS searching unit 106 that accesses the DNS (FIG. 1) to perform address resolution, and an IKE processing unit 107 that performs key exchange using IKE upon starting IPsec communications.

The OS 115 includes a network protocol processing unit 116 that performs processing according to a network protocol, and an I/F (Interface) processing unit (network communication driver) 120 that controls communication hardware (NIC: Network Interface Card). The network protocol processing unit 116 includes an IP processing unit 117 that performs processing according to protocols of IPv4 or IPv6, an IPsec processing unit 118 that performs IPsec processing, and an IPsec SA (Security Association) database 119 that holds currently effective IPsec settings.

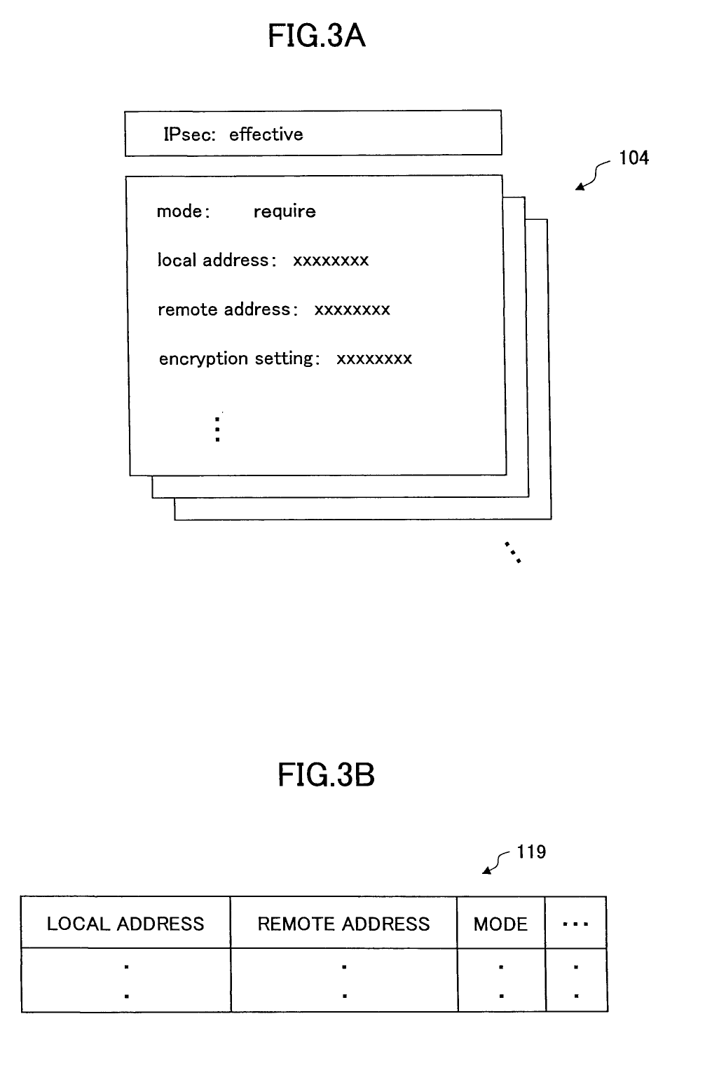

FIGS. 3A and 3B are diagrams showing exemplary data structures of the IPsec setting holding unit 104 and the IPsec SA database 119, respectively. The IPsec setting holding unit 104 shown in FIG. 3A holds information indicating whether IPsec is “enabled” or “disabled” in the network communication device 1A (“enabled” in FIG. 3A) and information indicating the mode of the IPsec (“require” means that the use of IPsec is a requirement; “used” means that the use of IPsec is optional; and “none” means IPsec is not used. the mode is set to “require” in FIG. 3A), and information of plural entries including encryption settings.

The IPsec SA database 119 shown in FIG. 3B holds, as currently effective IPsec settings, local addresses, remote addresses, and modes, etc.

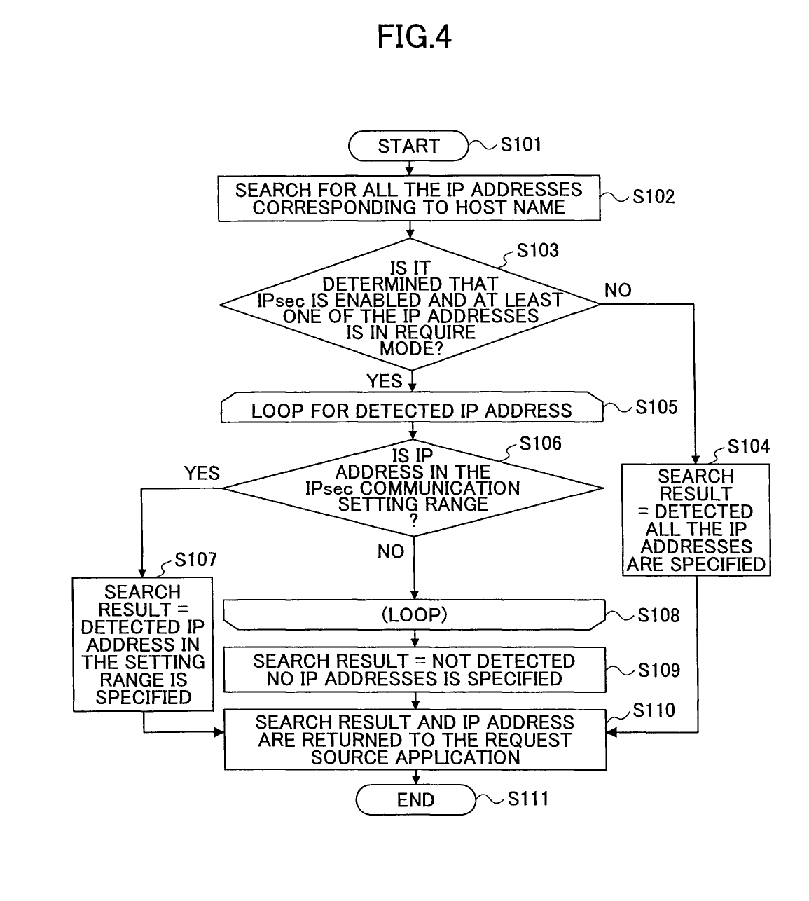

FIG. 4 is a flowchart showing an exemplary process performed by the network control unit 102 of the network communication device 1A. In this example, an IP address with which IPsec communications can be performed (hereinafter referred to as an “IPsec communication IP address”) is specified by referring to the IPsec settings by a user.

In FIG. 4, when a process starts in response to a request for communications with a host name specified from the upper level application 101 (Step S101), the DNS searching unit 106 searches for and obtains all the IP addresses corresponding to the specified host name by causing the DNS 2 to perform address resolution (Step S102).

Then, the IP address specifying unit 105 refers to the settings in the IPsec setting holding unit 104 to determine whether IPsec is enabled and at least one of the IP addresses is set to the “require” mode that requires the use of IPsec (Step S103).

If the determination is negative (No in Step S103), i.e., if IPsec is disabled or if IPsec is enabled but none of the IP addresses is set to the “require” mode (i.e., all of the IP addresses are set to either the “used” mode or the “none” mode), the search result is determined as “detected” and all the obtained IP addresses are specified (Step S104). The search result “detected” and all the IP addresses are returned to the request source application 101 (Step S110), and the process ends (Step S111).

If the determination is affirmative (Yes in Step S103), loop processing is performed on the obtained IP addresses (Steps S105-S108). This loop processing is performed first on the IP addresses of the “require” mode. It is determined whether the current IP address is present in the IPsec communication setting range (Step S106). If the current IP address is not present in the IPsec communication setting range (No in Step S106), the loop processing continues (Steps S108 and S105).

If the current IP address is present in the IPsec communication setting range (Yes in Step S106), the search result is determined as “detected” and the current IP address is specified (Step S107). The search result “detected” and the specified IP address are returned to the request source application 101 (Step S110), and the process ends (Step S111).

If loop processing for all the obtained IP addresses is completed, the search result is determined as “not detected” and none of the IP addresses is specified (Step S109). The search result “not detected” with no IP address is returned to the request source application 101 (Step S110), and the process ends (Step S111).

FIG. 4 is a flowchart showing another exemplary process performed by the network control unit 102 of the network communication device 1A. In this example, if an IP address in the IPsec communication setting range of the IPsec setting holding unit 104 is detected, it is determined whether IPsec communications can be performed by attempting to actually perform IPsec communications with the detected address. If it is determined that the attempt at IPsec communications is successful, the detected IP address is specified as an IPsec communication IP address.

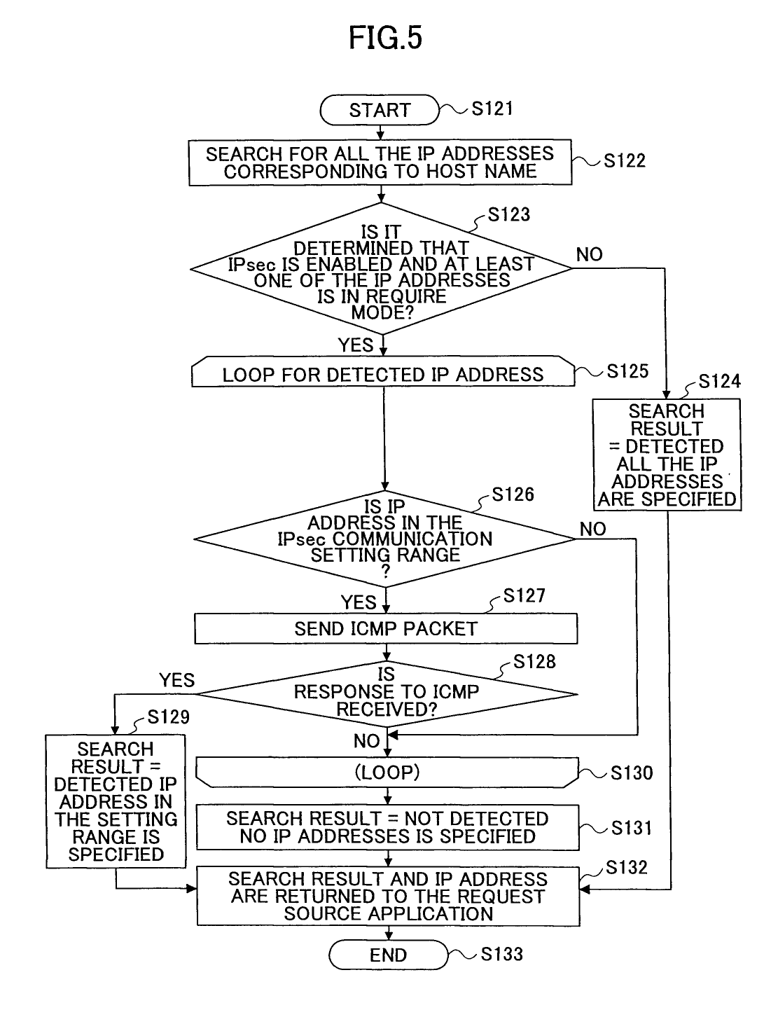

In FIG. 5, when a process starts in response to a request for communications with a host name specified from the upper level application 101 (Step S121), the DNS searching unit 106 searches for and obtains all the IP addresses corresponding to the specified host name by causing the DNS 2 to perform address resolution (Step S122).

Then, the IP address specifying unit 105 refers to the settings in the IPsec setting holding unit 104 to determine whether IPsec is enabled and at least one of the IP addresses is set to the “require” mode that requires the use of IPsec (Step S123).

If the determination is negative (No in Step S123), i.e., if IPsec is disabled or if IPsec is enabled but none of the IP addresses is set to the “require” mode (i.e., all of the IP addresses are set to either the “used” mode or the “none” mode), the search result is determined as “detected” and all the obtained IP addresses are specified (Step S124). The search result “detected” and all the IP addresses are returned to the request source application 101 (Step S132), and the process ends (Step S133).

If the determination is affirmative (Yes in Step S123), loop processing is performed on the obtained IP addresses (Steps S125-S130). This loop processing is performed first on the IP addresses of the “require” mode. It is determined whether the current IP address is present in the IPsec communication setting range (Step S126). If the current IP address is not present in the IPsec communication setting range (No in Step S126), the loop processing continues (Steps S130 and S125).

If the current IP address is present in the IPsec communication setting range (Yes in Step S126), the IP processing unit 117 transmits an ICMP (Internet Control Message Protocol) packet to the current IP address (Step S127). The transmission of an ICMP packet is performed after performing key exchange using IKE (IKE Phase 1, Phase 2, etc.,) with the device of the current IP address.

Then it is determined whether a response to the transmitted ICMP packet is received (Step S128). It is to be noted that if the transmission of an ICMP packet has failed due to an error in the key exchange using IKE, it is determined that no response is received as well.

If a response to the ICMP packet is received (Yes in Step S128), the search result is determined as “detected” and the current IP address is specified (Step S107). The search result “detected” and the specified IP address are returned to the request source application 101 (Step S132), and the process ends (Step S133).

If loop processing for all the obtained IP addresses is completed, the search result is determined as “not detected” and none of the IP addresses is specified (Step S131). The search result “not detected” with no IP address is returned to the request source application 101 (Step S132), and the process ends (Step S133).

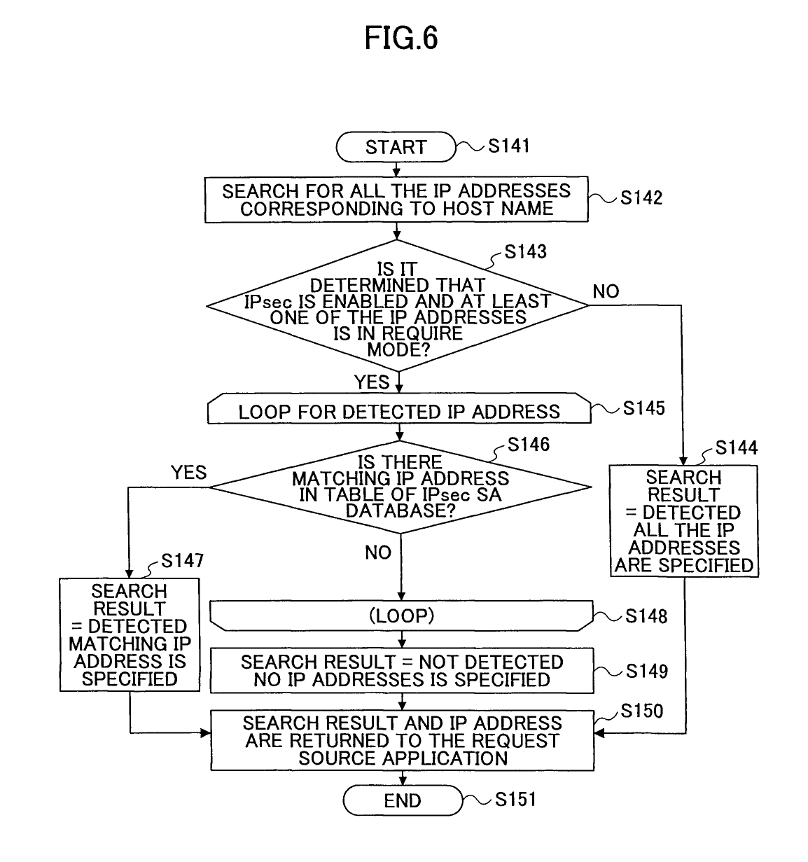

FIG. 6 is a flowchart showing still another exemplary process performed by the network control unit 102 of the network communication device 1A. In this example, an IPsec communication IP address is determined by referring to the IPsec SA database 119, which holds settings of the currently effective security communications, instead of referring to the IPsec setting holding unit 104.

In FIG. 6, when a process starts in response to a request for communications with a host name specified from the upper level application 101 (Step S141), the DNS searching unit 106 searches for and obtains all the IP addresses corresponding to the specified host name by causing the DNS 2 to perform address resolution (Step S142).

Then, the IP address specifying unit 105 refers to the settings in the IPsec setting holding unit 104 to determine whether IPsec is enabled and at least one of the IP addresses is set to the “require” mode that requires the use of IPsec (Step S143).

If the determination is negative (No in Step S143), i.e., if IPsec is disabled or if IPsec is enabled but none of the IP addresses is set to the “require” mode (i.e., all of the IP addresses are set to either the “used” mode or the “none” mode), the search result is determined as “detected” and all the obtained IP addresses are specified (Step S144). The search result “detected” and all the IP addresses are returned to the request source application 101 (Step S150), and the process ends (Step S151).

If the determination is affirmative (Yes in Step S143), loop processing is performed on the obtained IP addresses (Steps S145-S148). This loop processing is performed first on the IP addresses of the “require” mode. It is determined whether an IP address that matches the current IP address is present in the table of the IPsec SA database 119 (Step S146). If no matching IP address is present in the table of the IPsec SA database 119 (No in Step S146), the loop processing continues (Steps S148 and S145).

If a matching IP address is present in the IPsec communication setting range (Yes in Step S146), the search result is determined as “detected” and the current IP address is specified (Step S147). The search result “detected” and the specified IP address are returned to the request source application 101 (Step S150), and the process ends (Step S151).

If loop processing for all the obtained IP addresses is completed, the search result is determined as “not detected” and none of the IP addresses is specified (Step S149). The search result “not detected” with no IP address is returned to the request source application 101 (Step S150), and the process ends (Step S151).

As for the IP addresses in the IPsec SA database 119, because the IPsec SA database 119 holds currently effective IPsec settings that are not timed out, there is no need to determine whether IPsec communications can actually be performed by transmitting an ICMP packet and determining whether a response is received.

In this example, if loop processing for all the obtained IP addresses is completed, the search result is determined as “not detected” and none of the IP addresses is specified (Step S149). However, there is a case in which, although an IPsec communication IP address exists but the IPsec communication IP address is not present in the table of the IPsec SA database due to time out. In that case, an ICMP packet may be transmitted to all the IP addresses. Then the IP addresses from which responses are received may be returned to the request source application 101.

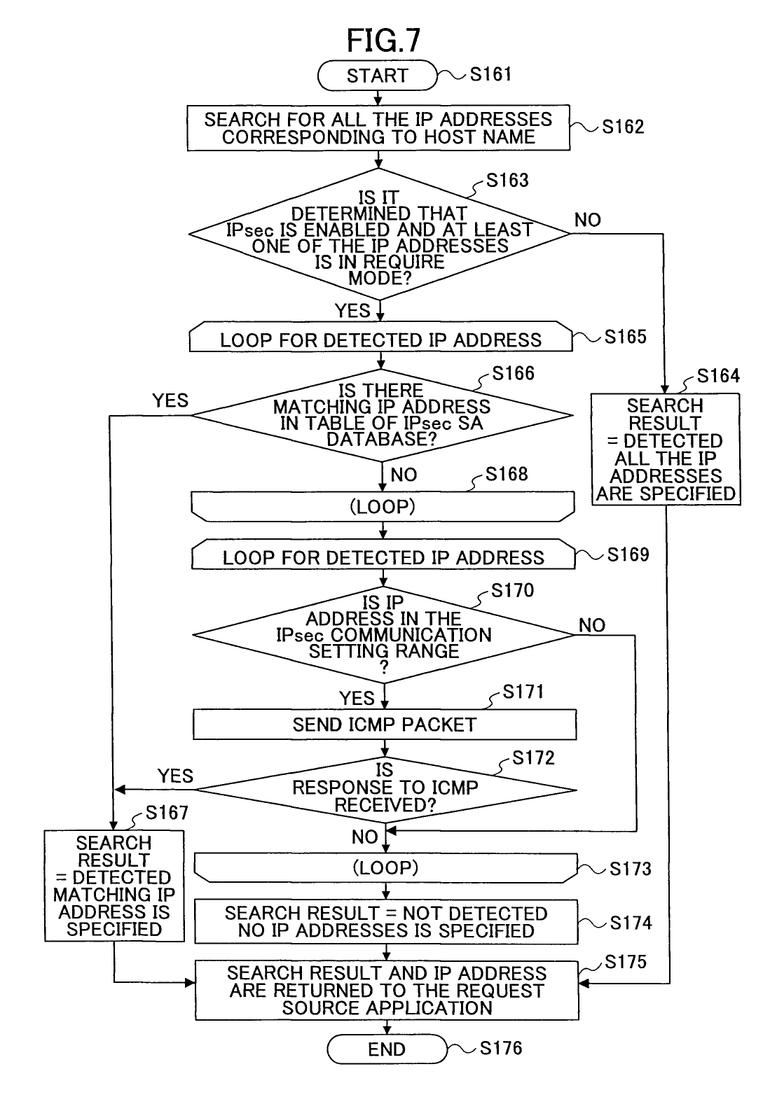

FIG. 7 is a flowchart showing a further exemplary process performed by the network control unit 102 of the network communication device 1A. In this example, the processing of FIG. 6 and the processing of FIG. 5 are combined, thereby improving the chances of detecting an IPsec communication IP address.

In FIG. 7, when a process starts in response to a request for communications with a host name specified from the upper level application 101 (Step S161), the DNS searching unit 106 searches for and obtains all the IP addresses corresponding to the specified host name by causing the DNS 2 to perform address resolution (Step S162).

Then, the IP address specifying unit 105 refers to the settings in the IPsec setting holding unit 104 to determine whether IPsec is enabled and at least one of the IP addresses is set to the “require” mode that requires-the use of IPsec (Step S163).

If the determination is negative (No in Step S163), i.e., if IPsec is disabled or if IPsec is enabled but none of the IP addresses is set to the “require” mode (i.e., all of the IP addresses are set to either the “used” mode or the “none” mode), the search result is determined as “detected” and all the obtained IP addresses are specified (Step S164). The search result “detected” and all the IP addresses are returned to the request source application 101 (Step S175), and the process ends (Step S176).

If the determination is affirmative (Yes in Step S163), loop processing is performed on the obtained IP addresses (Steps S165-S168). This loop processing is performed first on the IP addresses of the “require” mode. It is determined whether an IP address that matches the current IP address is present in the table of the IPsec SA database 119 (Step S166). If no matching IP address is present in the table of the IPsec SA database 119 (No in Step S166), the loop processing continues (Steps S168 and S165).

If a matching IP address is present in the IPsec communication setting range (Yes in Step S166), the search result is determined as “detected” and the current IP address is specified (Step S167). The search result “detected” and the specified IP address are returned to the request source application 101 (Step S175), and the process ends (Step S176).

If loop processing for all the obtained IP addresses is completed, another loop processing is performed on the obtained IP addresses (Steps S169-S173). This loop processing is performed first on the IP addresses of the “require” mode. It is determined whether the current IP address is present in the IPsec communication setting range (Step S170). If the current IP address is not present in the IPsec communication setting range (No in Step S170), the loop processing continues (Steps S173 and S169).

If the current IP address is present in the IPsec communication setting range (Yes in Step S170), the IP processing unit 117 transmits an ICMP (Internet Control Message Protocol) packet to the current IP address (Step S171). The transmission of an ICMP packet is performed after performing key exchange using IKE with the device of the current IP address.

Then it is determined whether a response to the transmitted ICMP packet is received (Step S172). It is to be noted that if the transmission of an ICMP packet has failed due to an error in the key exchange using IKE, it is determined that no response is received as well.

If a response to the ICMP packet is received (Yes in Step S172), the search result is determined as “detected” and the current IP address is specified (Step S167). The search result “detected” and the specified IP address are returned to the request source application 101 (Step S175), and the process ends (Step S176).

If loop processing for all the obtained IP addresses is completed, the search result is determined as “not detected” and none of the IP addresses is specified (Step S174). The search result “not detected” with no IP address is returned to the request source application 101 (Step S175), and the process ends (Step S176).

It is to be noted that, although it becomes slightly less certain that the IPsec communicating can be performed, the step of transmitting an ICMP packet (Step S171) and the step of determining whether a response is received may be omitted.

### Second Embodiment

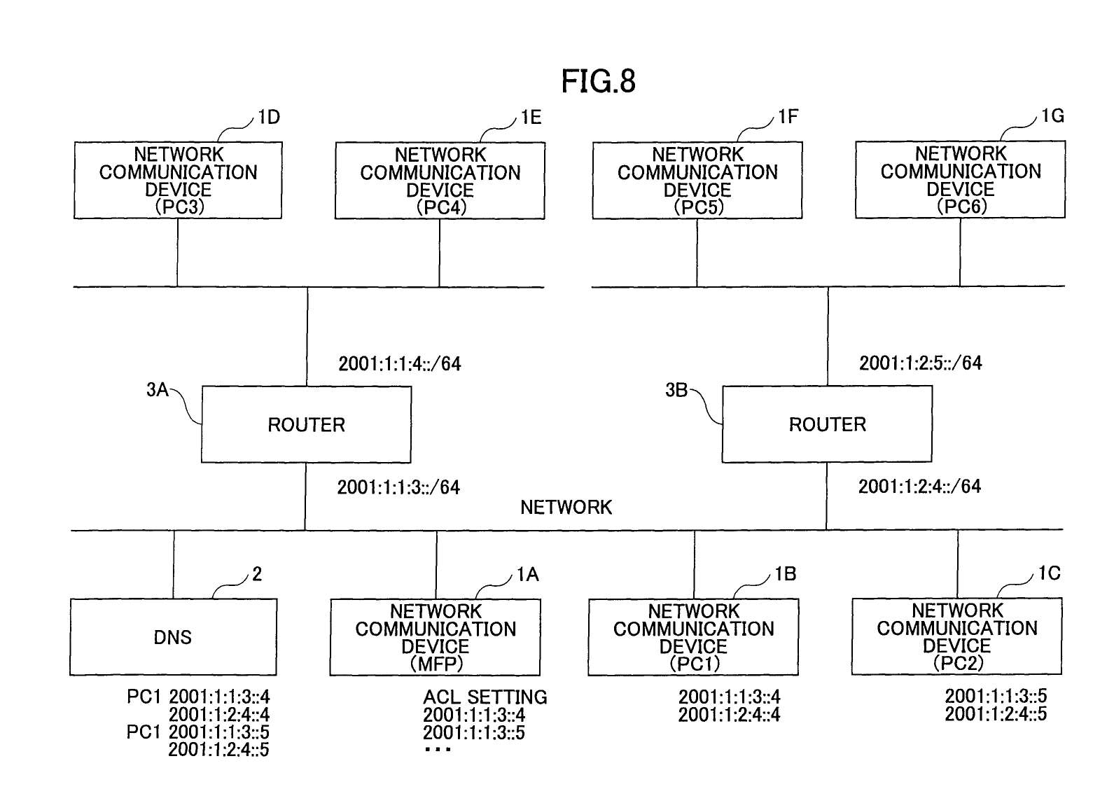

FIG. 8 is a block diagram showing an exemplary network configuration according to a second embodiment of the present invention.

In FIG. 8, a network communication device 1A such as an MFP, network communication devices 1B and 1C such as PCs, and a DNS 2 for performing address resolution are connected over a network. This network is connected via a router 3A and a router 3B to other networks, to which network communication devices 1D and 1E and network communication devices 1D and 1E such as PCs are connected, respectively. Numeric strings shown under the network communication devices 1B and 1C are examples of IPv6 addresses (128 bits are divided into groups of 16 bits, each group in hexadecimal form) assigned to the network communication devices 1B and 1C. Numeric strings shown under the network communication device 1A are examples of ACL (Access Control List) information indicating IP addresses of devices for which access is allowed (128 bits are divided into groups of 16 bits, each group in hexadecimal form) assigned to the devices of which access is permitted. Numeric strings shown under the DNS 2 are examples of correspondence information indicative of correspondence between host names and IP addresses.

In the following example, the present invention is applied to the network communication device 1A such as an MFP. However, it should be understood that the present invention is applicable to other network communication devices description.

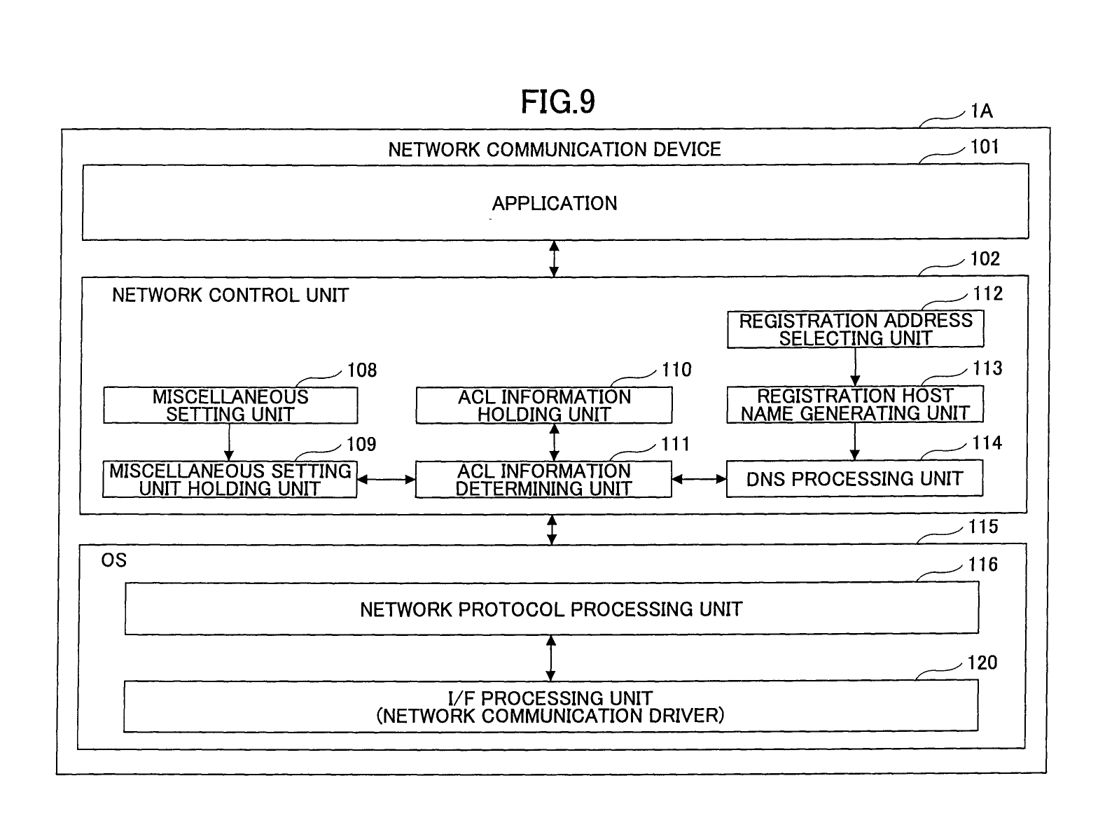

FIG. 9 is a diagram showing an exemplary software configuration of the network communication device 1A.

In FIG. 9, the network communication device 1A includes an application 101 that requests communications via the network, a network control unit 102 that controls network communications, and an OS 115 as basic software of the network communication device 1A.

The network control unit 102 includes a miscellaneous setting unit 108 that provides miscellaneous setting functions to be used by an administrator of the network communication device 1A, a miscellaneous setting holding unit 109 that holds miscellaneous settings, an ACL information holding unit 110 that holds association information (also referred to as “ACL information”) indicative of associations between host names of which access is permitted and their corresponding IP addresses, and an ACL information determining unit 111 that controls access by referring to the ACL information holding unit 110 and determining whether an IP address of the source of an access request is registered and updates the association information in the ACL information holding unit 110. The network control unit 102 further includes a registration address selecting unit 112 that selects an address to be registered in the DNS 2 (FIG. 1), a registration host name generating unit 113 that generates a host name to be registered, and a DNS processing unit 114 that performs registration into the DNS 2 and performs lookup (forward lookup and reverse lookup).

The OS 115 includes a network protocol processing unit 116 that performs processing according to a network protocol, and an I/F processing unit (network communication driver) 120 that controls communication hardware (NIC).

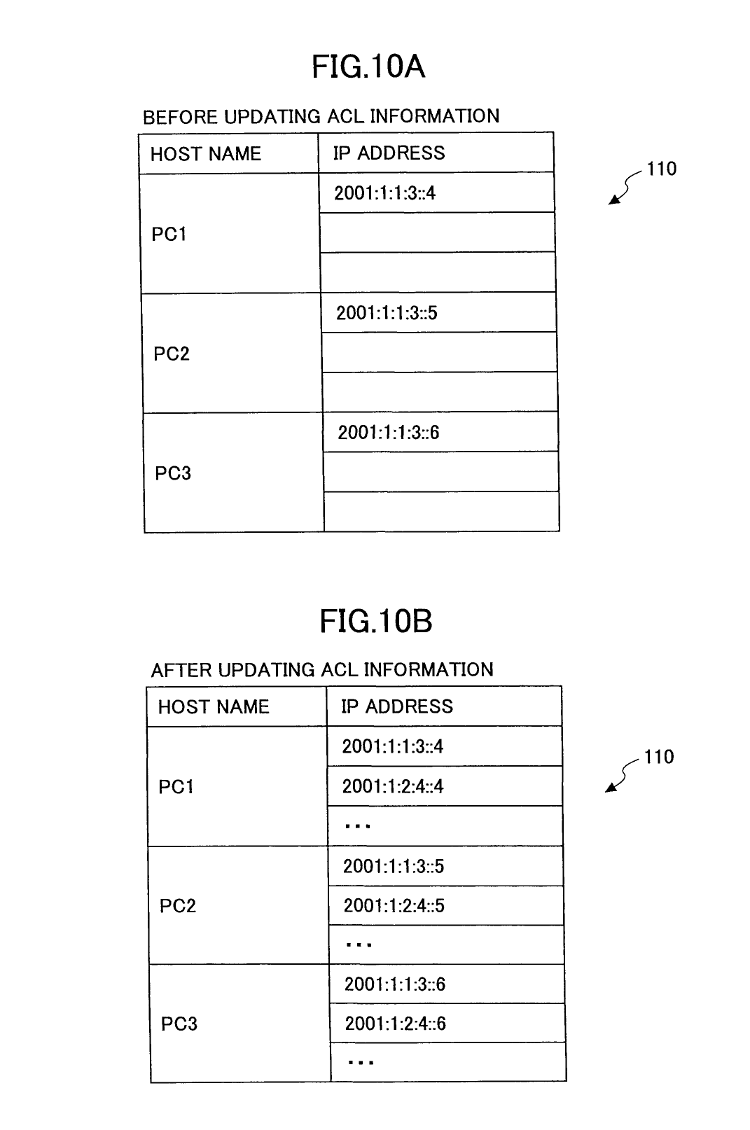

FIGS. 10A and 10B are diagrams showing exemplary data structures of the ACL information holding unit 110 before and after updating the ACL information, respectively. In the ACL information holding unit 110, each host name is associated with one or more corresponding IP addresses. Although the IP addresses shown in FIGS. 10A and 10B are IPv6 addresses, the IP addresses may be IPv4 addresses.

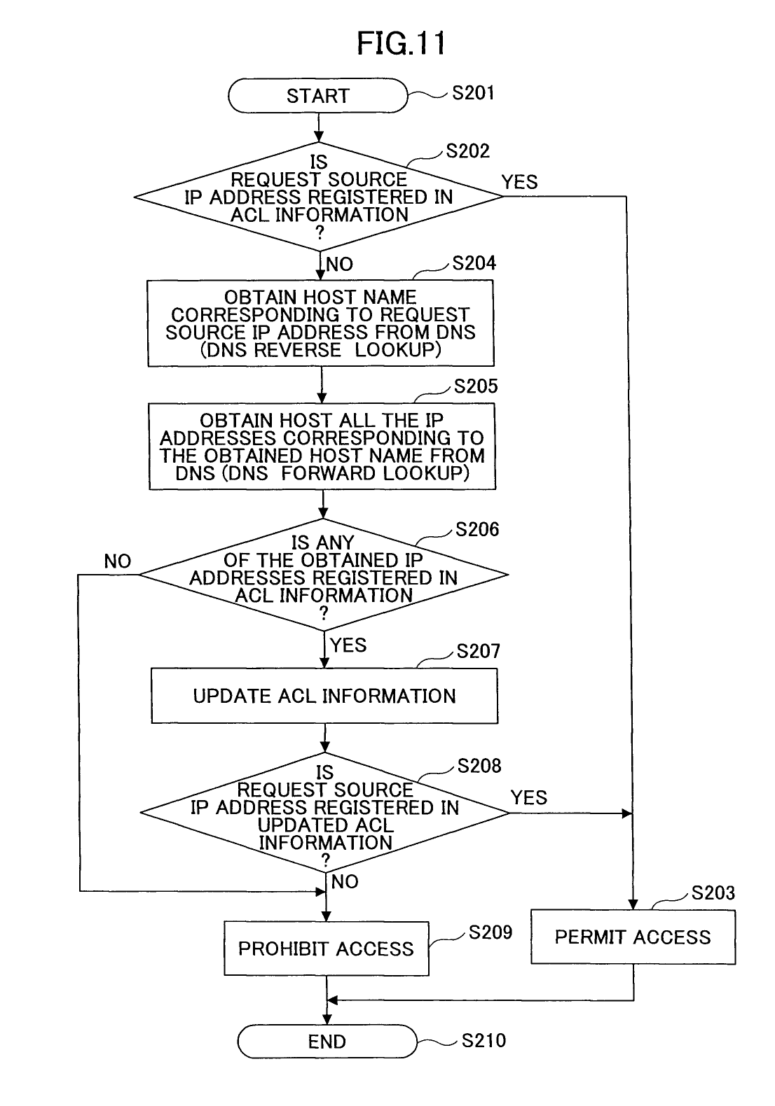

FIG. 11 is a flowchart showing an exemplary process performed by the network control unit 102 of the network communication device 1A.

In FIG. 11, when a process starts in response to an access request from an external network communication device (Step S201), the ACL information determining unit 111 determines whether an IP address of the request source is registered in the ACL information in the ACL information holding unit 110 (Step S202).

If the IP address of the request source is registered in the ACL information in the ACL information holding unit 110 (Yes in Step S202), access is permitted (Step S203) and then the process ends (Step S210).

If the IP address of the request source is not registered in the ACL information in the ACL information holding unit 110 (No in Step S202), the DNS processing unit 114 obtains a host name corresponding to the IP address from the DNS 2 by performing a DNS reverse lookup (Step S204) and then obtains all the IP addresses corresponding to the obtained host name from the DNS 2 by performing a DNS forward lookup (Step S205).

It is determined whether any of the obtained IP addresses is registered in the ACL information in the ACL information holding unit 110 (Step S206).

If none of the obtained IP addresses is registered in the ACL information in the ACL information holding unit 110 (No in Step S206), access is prohibited (Step S203) and then the process ends (Step S210).

If any of the obtained IP addresses is registered in the ACL information in the ACL information holding unit 110 (Yes in Step S206), the ACL information in the ACL information holding unit 110 is updated (Step S207). More specifically, information indicating the IP address associated with the host name is updated.

It is determined whether the IP address of the request source is registered in the updated ACL information in the ACL information holding unit 110 (Step S208).

If the IP address of the request source is registered in the updated ACL information in the ACL information holding unit 110 (Yes in Step S202), access is permitted (Step S203) and then the process ends (Step S210).

If the IP address of the request source is not contained as a registration address in the updated ACL information in the ACL information holding unit 110 (No in Step S208), access is prohibited (Step S211) and then the process ends (Step S210).

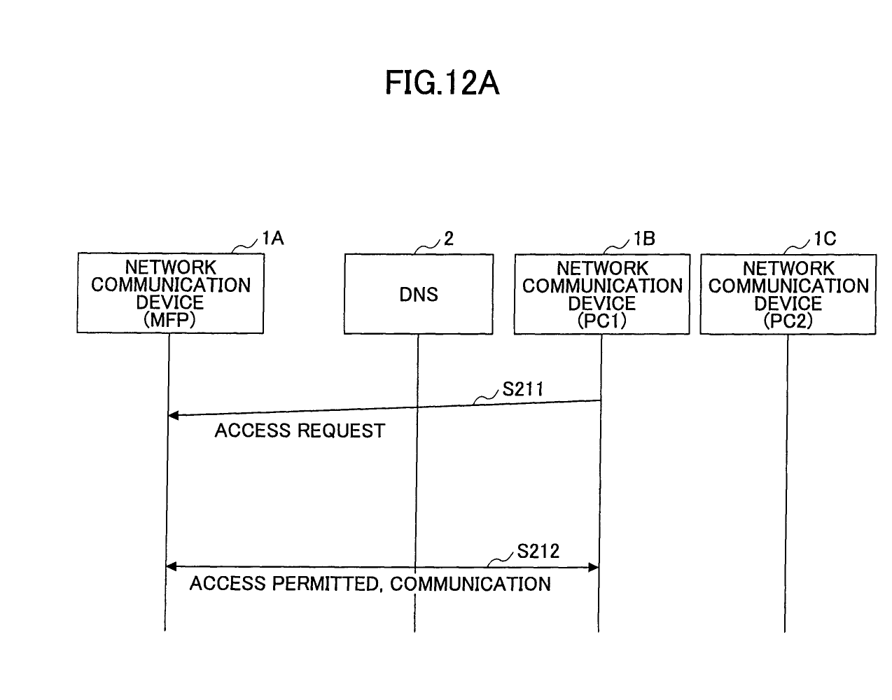

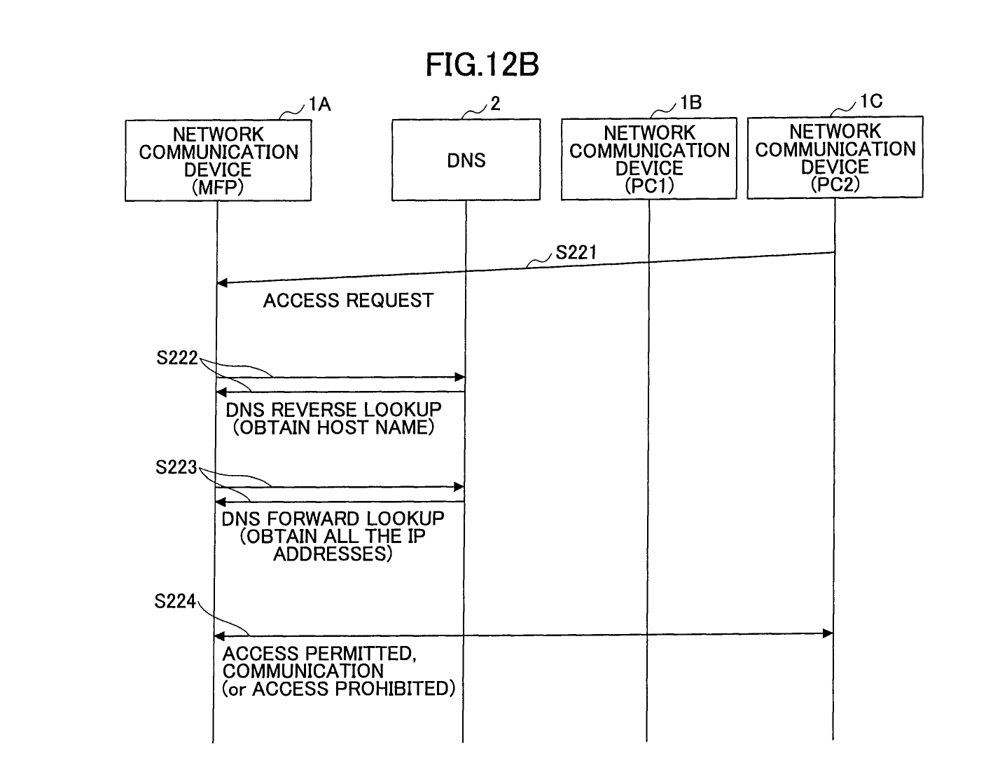

FIGS. 12A and 12B are sequence diagrams each showing an exemplary process of transmitting signals between devices. FIG. 12A illustrates a process in the case where the IP address of the request source is registered in the ACL information in the ACL information holding unit 110. The 12B illustrates a process in the case where the IP address of the request source is registered in the ACL information in the ACL information holding unit 110.

In FIG. 12A, the network communication device (PC 1) 1B sends an access request to the network communication device (MFP) 1A (Step S211). Then the network communication device 1A determines whether an IP address of the network communication device 1B which sent the access request is registered in the ACL information in the ACL information holding unit 110. For example, if the ACL information holding unit 110 contains information as shown in FIG. 10A at this point and the IP address of the network communication device 1B which sent the access request is “2001:1:1:3::4”, this IP address matches the IP address “2001:1:1:3::4” associated with the host name “PC 1”, so that access is permitted to perform communications (Step S212).

In FIG. 12B, the network communication device (PC 2) 1C sends an access request to the network communication device (MFP) 1A (Step S221). Then the network communication device 1A determines whether an IP address of the network communication device 1C which sent the access request is registered in the ACL information in the ACL information holding unit 110. For example, if the ACL information holding unit 110 contains information as shown in FIG. 10A at this point and the IP address of the network communication device 1C which sent the access request is “2001:1:2:4::5”, this IP address is determined not to be registered.

Then the network communication device 1A obtains the host name corresponding to the IP address “2001:1:2:4::5” from the DNS 2 by performing a DNS reverse lookup (Step S222). In this example, a host name “PC 2” is obtained.

Then all the IP addresses corresponding to the obtained host name “PC 2” from the DNS 2 by performing a DNS forward lookup. In this example, IP addresses “2001:1:1:3::5” and “2001:1:2:4::5” are obtained.

Then, if either one of the obtained IP addresses “2001:1:1:3::5” and “2001:1:2:4::5” is registered in the ACL information in the ACL information holding unit 110, the ACL information in the ACL information holding unit 110 is updated. In this example, because the IP address “2001:1:1:3::5” matches the IP address “2001:1:1:3::5” associated with “PC 2”, the IP address “2001:1:2:4::5” is associated with “PC 2” and added to the ACL information. As a result, the data portion related to the host name “PC 2” is updated as shown in FIG. 10B. If none of the obtained IP addresses is registered in the ACL information in the ACL information holding unit 110, an update of the ACL information is not performed.

Then the network communication device 1A determines whether the IP address of the network communication device 1C which sent the access request is registered in the updated ACL information in the ACL information holding unit 110. For example, if the ACL information holding unit 110 contains information as shown in FIG. 10B at this point, the IP address “2001:1:2:4::5” of the network communication device 1C which sent the access request matches the IP address “2001:1:2:4::5” associated with the host name “PC 2”, so that access is permitted to perform communications (Step S224). If the IP address of the network communication device 1C which sent the access request is not registered in the updated ACL information in the ACL information holding unit 110, access is prohibited.

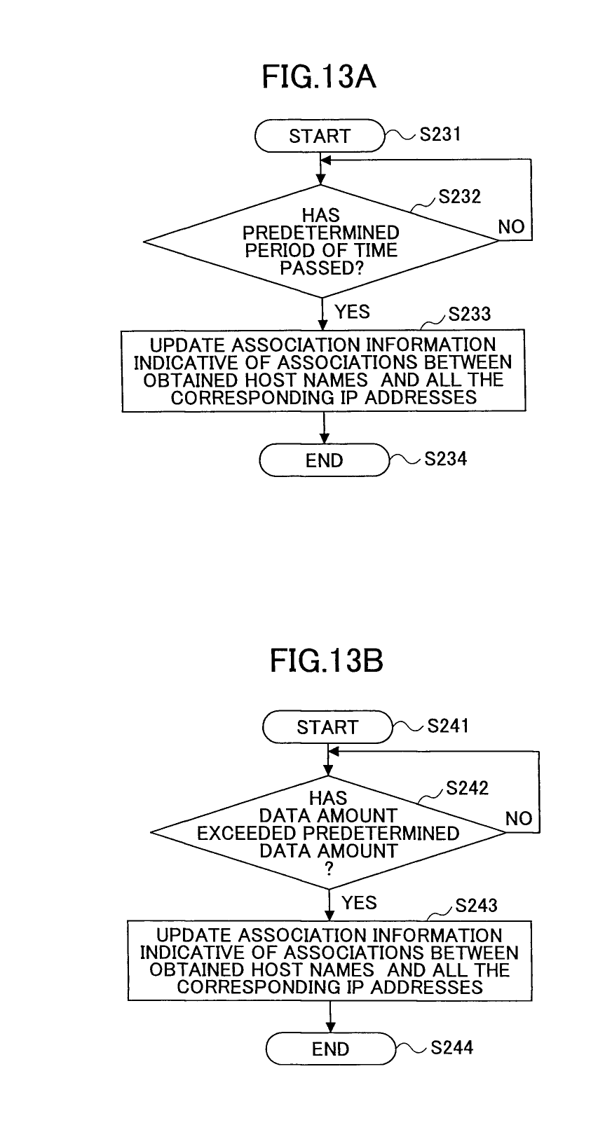

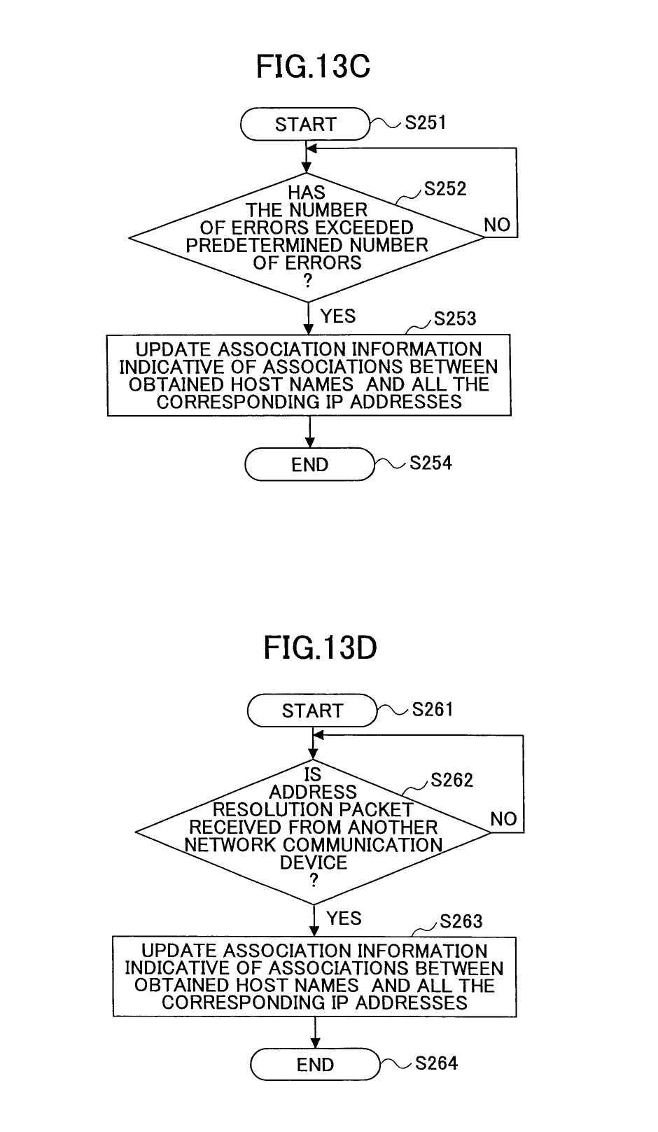

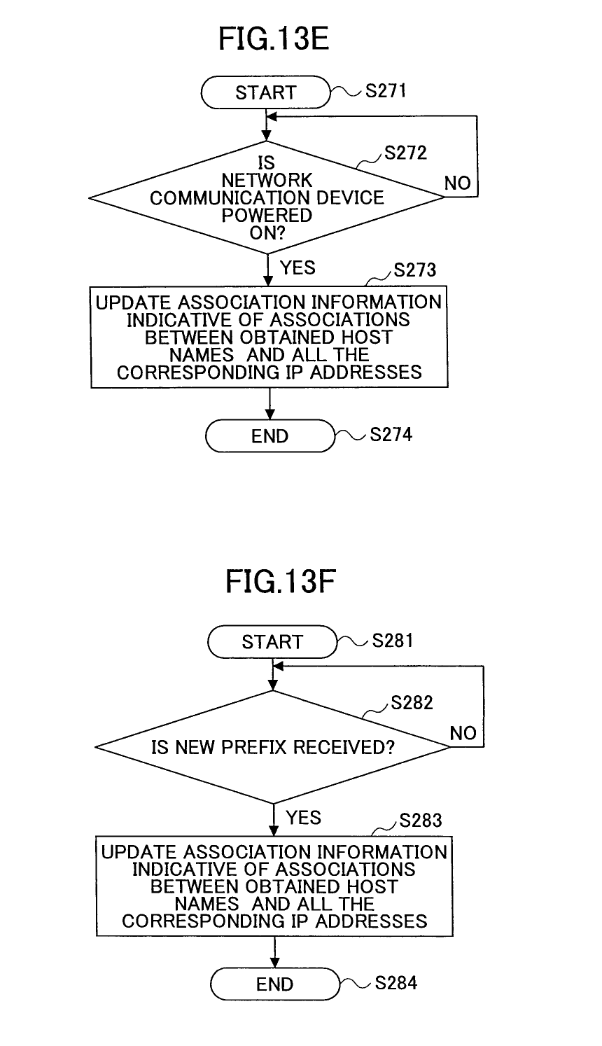

FIGS. 13A-13F are flowcharts each showing an exemplary process of updating the association information. The association information in the ACL information holding unit 110, which indicates associations between obtained host names and all the corresponding IP addresses, changes frequently depending on the network environment and the status of connection devices. Therefore, updating the association information is performed at appropriate timings, thereby preventing incorrect access control due to the association information being old.

The process shown in FIG. 13A is for updating the association information if a predetermined period of time has passed. Because association information may become old after a predetermined period of time, an update of the association information is performed. The predetermined period of time can be specified in the network communication device 1A by a network administrator.

In FIG. 13A, when the process starts (Step S231), it is determined whether a predetermined period of time has passed (Step S232). If a predetermined period of time is determined to have passed (Yes in Step S232), the association information in the ACL information holding unit 110 indicating associations between obtained host names and all the corresponding IP addresses is updated (Step S233), and then the process ends (Step S234). The update of the association information is performed by obtaining IP addresses corresponding to all the host names registered in the ACL information in the ACL information holding unit 110 using DNS forward lookup and updating with the obtained IP addresses.

The process shown in FIG. 13B is for updating the association information if the data amount has exceeded a predetermined data amount. If the data amount has exceeded a predetermined data amount, because there is a possibility that unauthorized access such as DOS attack (Denial of Service Attack) has been made, an update of the association information is performed. The predetermined data amount can be specified in the network communication device 1A by a network administrator.

In FIG. 13B, when the process starts (Step S241), it is determined whether the data amount has exceed a predetermined data amount (Step S242). If the data amount is determined to have exceeded a predetermined data amount (Yes in Step S242), the association information in the ACL information holding unit 110 indicating associations between obtained host names and all the corresponding IP addresses is updated (Step S243), and then the process ends (Step S244). The update of the association information is performed by obtaining IP addresses corresponding to all the host names registered in the ACL information in the ACL information holding unit 110 using DNS forward lookup and updating with the obtained IP addresses.

The process shown in FIG. 13C is for updating the association information if the number of errors exceeds a predetermined number of errors. If the number of errors has exceeded a predetermined number of errors, because there is a possibility that many errors have occurred due to unknown packets from unauthorized access or the like, an update of the association information is performed. The predetermined number of errors can be specified in the network communication device 1A by a network administrator.

In FIG. 13C, when the process starts (Step S251), it is determined whether the number of errors has exceeded a predetermined number of errors (Step S252). If the number of errors is determined to have exceeded the predetermined number of errors (Yes in Step S252), the association information in the ACL information holding unit 110 indicating associations between obtained host names and all the corresponding IP addresses is updated (Step S253), and then the process ends (Step S254). The update of the association information is performed by obtaining IP addresses corresponding to all the host names registered in the ACL information in the ACL information holding unit 110 using DNS forward lookup and updating with the obtained IP addresses.

The process shown in FIG. 13D is for updating the association information if an address resolution packet is received from another network communication device. If an address resolution packet is received from another network communication device, because the association information may already be old, update of the association information is performed.

In FIG. 13D, when the process starts (Step S261), it is determined whether an address resolution packet is received from another network communication device (Step S262). If an address resolution packet is determined to be received from another network communication device (Yes in Step S262), the association information in the ACL information holding unit 110 indicating associations between obtained host names and all the corresponding IP addresses is updated (Step S263), and then the process ends (Step S264). The update of the association information is performed by obtaining IP addresses corresponding to all the host names registered in the ACL information in the ACL information holding unit 110 using DNS forward lookup and updating with the obtained IP addresses.

The process shown in FIG. 13E is for updating the association information when a network communication device is powered on. Because the association information may be already be old or be lost when a network communication device is powered on, update of the association information is performed.

In FIG. 13E, when the process starts (Step S271), a network communication device is powered on (Step S272). The association information in the ACL information holding unit 110 indicating associations between obtained host names and all the corresponding IP addresses is updated (Step S273), and then the process ends (Step S274). The update of the association information is performed by obtaining IP addresses corresponding to all the host names registered in the ACL information in the ACL information holding unit 110 using DNS forward lookup and updating with the obtained IP addresses.

The process shown in FIG. 13F is for updating the association information if a new prefix (prefix of an RA (Router Advertisement) of IPv6) is received from a router. Because a new prefix is received when a router is added to the same segment as the segment of the network communication device, update of the association information is performed based on a determination that a new router has been added.

In FIG. 13F, when the process starts (Step S281), it is determined whether a new prefix is received from a router (Step S282). If a new prefix is received from a router (Yes in Step S282), the association information in the ACL information holding unit 110 indicating associations between obtained host names and all the corresponding IP addresses is updated (Step S283), and then the process ends (Step S284). The update of the association information is performed by obtaining IP addresses corresponding to all the host names registered in the ACL information in the ACL information holding unit 110 using DNS forward lookup and updating with the obtained IP addresses.

<Summary>

As described above, embodiments of the present invention provide the following advantages.

(1) An IP address to which IPsec communication is applied and in a condition for IPsec communication can be specified by comparing IP addresses, detected based on a host name, to the settings in the IPsec setting holding unit. Communications are performed using the thus specified IP address, thereby allowing the application to perform its processing without caring about the IPsec communication settings. Furthermore, there is no need to send unnecessary packets.

(2) It is possible to determine whether communication cannot be performed with a specified IP address due to an error in the IPsec communication settings by attempting to actually perform communication with the specified IP address. When the attempt is made, preprocessing in IKE is performed. Furthermore, the application can process a response with little difference between when implementing IPsec and when not implementing IPsec because a time-consuming key exchange in IKE has been completed.

(3) An IP address actually in a condition for IPsec communication can be specified by comparing IP addresses, detected based on a host name, to the settings in the IPsec SA database. Communications are performed using the thus specified IP address, thereby allowing the application to perform its processing without caring about the IPsec communication settings. There is no need to send unnecessary packets. Furthermore, the application can process a response with little difference between when implementing IPsec and when not implementing IPsec because a time-consuming key exchange in IKE has been completed.

(4) Information about devices with which IPsec communication has never been performed can be created in the IPsec SA database by sending ICMP packets to the devices. Therefore, without sending ICMP packets to all the devices, it is possible to perform a search for a device with which communications can actually be performed while communication routes are secured by using minimum packets. Furthermore, the application can process a response with little difference between when implementing IPsec and when not implementing IPsec because a time-consuming key exchange in IKE has been completed.

(5) If an IPsec communication IP address cannot be specified by referring to the IPsec SA database, then an IPsec communication IP address is specified by referring to the IPsec setting holding unit. Therefore, the chances of being able to specify an IPsec communication IP address of a device is improved even if IPsec communications have never been performed with the device.

(6) A host name is detected based on an IP address, and then all the IP addresses assigned to the host name are obtained. The host name is then associated with the obtained IP addresses. Thus access control is performed over the host corresponding to these IP addresses. Therefore, even if an access control setting in a network communication device is applied to only one of IP addresses of a host, accesses from the other addresses of the host can be properly controlled.

(7) The association information, which indicates association between the host name and all the corresponding IP addresses, changes frequently depending on the network environment and the status of connection devices. Old association information can result in incorrect access control. Updating the association information at predetermined timings can prevent such incorrect access control.

In the above, the present invention is described in terms of preferred embodiments of the present invention. Although the present invention is described above with reference to specific embodiments, it will be apparent to those skilled in the art that changes and modifications can be made without departing from the spirit and scope of the present invention as set forth in the appended claims. The present invention is not limited to t-he description of the specific embodiments and the attached drawings.

In an embodiment of the present invention, there is provided a method of controlling a network communication device having plural addresses, the method comprising an address obtaining step of, if the network communication device receives an access request from another network communication device with an address access from which address is not permitted, obtaining a host name corresponding to the address, and obtaining plural addresses corresponding to the obtained host name; and an access controlling step of controlling access of the other network communication device based on the obtained addresses.

The present application is based on Japanese Priority Application No. 2007-157654 filed on Jun. 14, 2007, with the Japanese Patent Office, the entire contents of which are hereby incorporated herein by reference.

What is claimed is:

1. A network communication device having plural addresses, the network communication device comprising:
an address obtaining unit configured to obtain plural addresses corresponding to a name or an identifier of another network communication device by address resolution; and
an address specifying unit configured to specify one or more of the obtained addresses as security communication addresses with which security communication can be performed by comparing the obtained addresses to a setting of the security communication.

2. The network communication device as claimed in claim 1, further comprising:
a setting holding unit configured to hold a user-specified setting of the security communication;
wherein the setting of the security communication to which the obtained addresses are compared includes the user-specified setting of the security communication obtained from the setting holding unit.

3. The network communication device as claimed in claim 1, further comprising:
a database configured to hold a currently-effective setting of the security communication;
wherein the setting of the security communication to which the obtained addresses are compared includes the currently-effective setting of the security communication obtained from the database.

4. The network communication device as claimed in claim 1, further comprising:
a database configured to hold a currently-effective setting of the security communication; and
a setting holding unit configured to hold a user-specified setting of the security communication; wherein
the address specifying unit specifies one or more of the obtained addresses as security communication addresses by comparing the obtained addresses to a first setting of the security communication and, if none of the obtained addresses is specified as a security communication address, specifies one or more of the obtained addresses as security communication addresses by comparing the obtained addresses to a second setting of the security communication;
the first setting of the security communication includes the currently-effective setting of the security communication obtained from the database; and
the second setting of the security communication includes the user-specified setting of the security communication obtained from the setting holding unit.

5. The network communication device as claimed in claim 1, wherein, if at least one of the obtained addresses is set to a mode requiring the security communication in the setting of the security communication, the address specifying unit specifies one or more of the obtained addresses as security communication addresses by comparing the obtained addresses to the setting of the security communication.

6. The network communication device as claimed in claim 1, wherein, after determining that security communication can actually be performed with one or more of the obtained addresses after the comparison by attempting to actually perform security communication with said one or more of the obtained addresses, the address specifying unit specifies said one or more of the obtained addresses as security communication addresses.

7. The network communication device as claimed in claim 3, wherein, if the address specifying unit cannot specify one or more of the obtained addresses as security communication addresses by comparing the obtained addresses to the setting of the security communication, the address specifying unit attempts security communication with the obtained addresses and specifies, as security communication addresses, one or more of the obtained addresses with which the attempt of the security communication is successful.

8. A network communication device having plural addresses, the network communication device comprising:
an address obtaining unit configured to, if an access request is received from another network communication device with an address access from which address is not permitted, obtain a host name corresponding to the address, and obtain plural addresses corresponding to the obtained host name; and
an access controlling unit configured to control access of said other network communication device based on the obtained addresses.

9. The network communication device as claimed in claim 8, further comprising:
an association information holding unit configured to hold association information indicative of association between a host name access from which is permitted and plural addresses corresponding to the host name; and
an updating unit configured to update the association information at predetermined timings.

10. A method of controlling a network communication device having plural addresses, the method comprising:
an address obtaining step of obtaining plural addresses corresponding to a name or an identifier of another network communication device by address resolution; and
an address determining step of specifying one or more of the obtained addresses as security communication addresses with which security communication can be performed by comparing the obtained addresses to a setting of the security communication.
